(19) United States
(12) Patent Application Publication
(10) Pub. No.: US 2026/0045493 A1
(43) Pub. Date: Feb. 12, 2026

(54) POSITIVE ELECTRODE FOR RECHARGEABLE LITHIUM BATTERY AND RECHARGEABLE LITHIUM BATTERY INCLUDING THE SAME

(71) Applicant: SAMSUNG SDI CO., LTD., Yongin-si (KR)

(72) Inventors: Youngkwang CHO, Yongin-si (KR); Seung-Hun HAN, Yongin-si (KR); Hyunwoo KIM, Yongin-si (KR); Moonju CHO, Yongin-si (KR); Seunghyun JEON, Yongin-si (KR); Seunghyun LIM, Yongin-si (KR); Beom Kwon KIM, Yongin-si (KR)

(73) Assignee: SAMSUNG SDI CO., LTD., Yongin-si (KR)

(21) Appl. No.: 19/269,833

(22) Filed: Jul. 15, 2025

(30) Foreign Application Priority Data
Aug. 9, 2024 (KR) 10-2024-0106540

(51) Int. Cl. H01M 4/525; H01M 4/02; H01M 4/131; H01M 4/62; H01M 4/66; H01M 10/0525

(52) U.S. Cl. CPC H01M 4/525; H01M 4/131; H01M 4/623; H01M 4/626; H01M 4/661; H01M 4/667; H01M 10/0525; H01M 2004/021; H01M 2004/028

(57) ABSTRACT

Disclosed are positive electrodes, and rechargeable lithium batteries including the positive electrodes. A positive electrode includes a composite substrate that includes a first metal layer, a second metal layer, and a polymer layer between the first metal layer and the second metal layer, a protection layer on the first metal layer, and a positive electrode active material layer on the protection layer. The protection layer includes boron nitride particles.

### CROSS-REFERENCE TO RELATED APPLICATION

This U.S. nonprovisional application claims priority under 35 U.S.C § 119 to Korean Patent Application No. 10-2024-0106540 filed on Aug. 9, 2024 in the Korean Intellectual Property Office, the disclosure of which is hereby incorporated by reference in its entirety.

### BACKGROUND

The present disclosure relates to a positive electrode for a rechargeable lithium battery, and a rechargeable lithium battery including the positive electrode.

With increasing presence of battery-using electronic devices, such as, e.g., mobile phones, laptop computers, electric vehicles, and the like, there is increasing demand for rechargeable batteries with high energy density and high capacity. Therefore, improving performance of rechargeable lithium batteries may be advantageous.

A rechargeable lithium battery typically includes a positive electrode, a negative electrode, and an electrolyte, the positive and negative electrodes include an active material in which intercalation and deintercalation are possible, and the rechargeable lithium battery generates electrical energy caused by oxidation and reduction reactions when lithium ions are intercalated and deintercalated.

### SUMMARY

An example embodiment of the present disclosure includes a positive electrode having desired or improved safety for a rechargeable lithium battery.

An example embodiment of the present disclosure includes a rechargeable lithium battery having desired or improved safety.

According to an example embodiment of the present disclosure, a positive electrode for a rechargeable lithium battery may include a composite substrate that includes a first metal layer, a second metal layer, and a polymer layer between the first metal layer and the second metal layer, a protection layer on the first metal layer, and a positive electrode active material layer on the protection layer. The protection layer may include boron nitride particles.

According to an example embodiment of the present disclosure, a positive electrode for a rechargeable lithium battery may include a composite substrate that includes a first metal layer, a second metal layer, and a polymer layer between the first metal layer and the second metal layer, a first protection layer on a top surface of the first metal layer, a second protection layer on a bottom surface of the second metal layer, a first positive electrode active material layer on a top surface of the first protection layer, and a second positive electrode active material layer on a bottom surface of the second protection layer. Each of, or at least one of, the first and second protection layers may include boron nitride particles.

According to an example embodiment of the present disclosure, a rechargeable lithium battery may include a positive electrode, a negative electrode, and a separator between the positive electrode and the negative electrode. The positive electrode may include a composite substrate that includes a first metal layer, a second metal layer, and a polymer layer between the first metal layer and the second metal layer, a protection layer on the first metal layer, wherein the protection layer includes boron nitride, and a positive electrode active material layer on the protection layer.

### BRIEF DESCRIPTION OF DRAWINGS

FIG. 1 illustrates a simplified conceptual diagram illustrating a rechargeable lithium battery, according to an example embodiment of the present disclosure.

FIGS. 2 to 5 illustrate simplified diagrams illustrating a rechargeable lithium battery, according to an example embodiment of the present disclosure.

FIG. 6 illustrates a cross-sectional view illustrating a rechargeable lithium battery, according to an example embodiment of the present disclosure.

FIG. 7 illustrates a cross-sectional view illustrating a rechargeable lithium battery, according to an example embodiment of the present disclosure.

FIG. 8 illustrates an enlarged view illustrating a positive electrode, according to an example embodiment of the present disclosure.

FIGS. 9A and 9B illustrate simplified conceptual diagrams illustrating a principle of reducing or preventing a short circuit caused by penetration in a positive electrode, according to a comparative example of the present disclosure.

FIG. 10 illustrates a simplified conceptual diagram illustrating a principle of reducing or preventing a short circuit caused by penetration in a positive electrode, according to an example embodiment of the present disclosure.

FIGS. 11A to 11C illustrate graphs illustrating changes with time in temperature and voltage after penetration in Embodiments 1, 6, and 7 in order.

FIGS. 12A and 12B illustrate graphs illustrating changes with time in temperature and voltage after penetration in Comparatives 1 and 2 in order.

### DETAILED DESCRIPTION OF EMBODIMENTS

In order to sufficiently understand the configuration and effect of the present disclosure, some example embodiments of the present disclosure are described with reference to the accompanying drawings. It should be noted, however, that the present disclosure is not limited to the following example embodiments, and may be implemented in various forms. Rather, the example embodiments are provided only to disclose the present disclosure and let those skilled in the art fully know the scope of the present disclosure.

In this description, it is understood that, when an element is referred to as being “on” another element, the element can be “directly on” the other element, or intervening elements may be present between therebetween. In the drawings, thicknesses of some components are exaggerated for effectively explaining the technical contents. Like reference numerals refer to like elements throughout the specification.

Unless otherwise specially noted in this description, the expression of singular form may include the expression of plural form. In addition, unless otherwise specially noted, the phrase “A or B” may indicate “A but not B,” “B but not A,” and “A and B.” The terms “comprises/includes” and/or “comprising/including” included in this disclosure do not exclude the presence or addition of one or more other components.

As included herein, the term “combination thereof” may refer to a mixture, a stack, a composite, a copolymer, an alloy, a blend, or a reaction product.

Unless otherwise especially defined in this description, a particle diameter may be an average particle diameter. In addition, a particle diameter indicates an average particle diameter (D₅₀) where a cumulative volume is about 50 volume % in a particle size distribution. The average particle diameter (D₅₀) may be measured by a method widely known to those skilled in the art, for example, by a particle size analyzer, a transmission electron microscope (TEM) image, or a scanning electron microscope (SEM) image. Alternatively, a dynamic light-scattering measurement device is included to perform a data analysis, the number of particles is counted for each particle size range, and then from this, an average particle diameter (D₅₀) value may be obtained through a calculation. Dissimilarly, a laser scattering method may be utilized to measure the average particle diameter (D₅₀). In the laser scattering method, a target particle is distributed in a dispersion solvent, introduced into a laser scattering particle measurement device (e.g., MT3000 commercially available from Microtrac, Inc), irradiated with ultrasonic waves of 28 kHz at a power of 60 W, and then an average particle diameter (D₅₀) is calculated in the 50% standard of particle diameter distribution in the measurement device.

When the terms “about” or “substantially” are used in this specification in connection with a numerical value, it is intended that the associated numerical value include a tolerance of ±10% around the stated numerical value. When ranges are specified, the range includes all values therebetween such as increments of 0.1%.

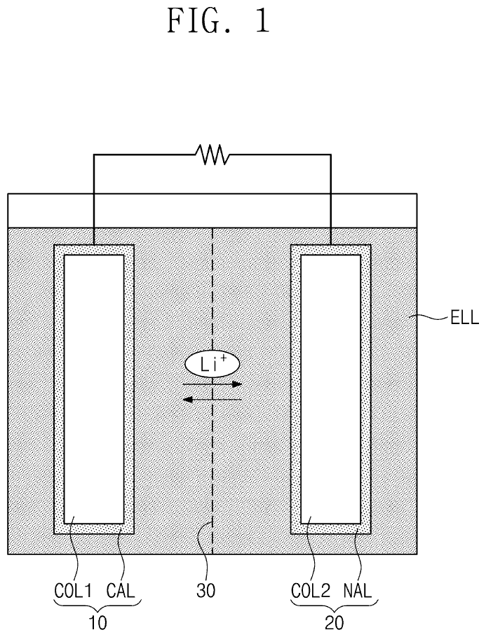

FIG. 1 illustrates a simplified conceptual diagram illustrating a rechargeable lithium battery, according to an example embodiment of the present disclosure. Referring to FIG. 1, a rechargeable lithium battery may include a positive electrode 10, a negative electrode 20, a separator 30, and an electrolyte ELL.

The positive electrode 10 and the negative electrode 20 may be spaced apart from each other across the separator 30. The separator 30 may be located between the positive electrode 10 and the negative electrode 20. The positive electrode 10, the negative electrode 20, and the separator 30 may be in contact with the electrolyte ELL. The positive electrode 10, the negative electrode 20, and the separator 30 may be impregnated in the electrolyte ELL.

The electrolyte ELL may be or include a medium by which lithium ions are transferred between the positive electrode 10 and the negative electrode 20. In the electrolyte ELL, the lithium ions may move through the separator 30 toward one of the positive electrode 10 and the negative electrode 20.

### Positive Electrode 10

The positive electrode 10 for a rechargeable lithium battery may include a current collector COL1 and a positive electrode active material layer CAL formed on the current collector COLL. The positive electrode active material layer CAL may include a positive electrode active material, and may further include a binder and/or a conductive material.

For example, the positive electrode 10 may further include an additive that can be configured as a sacrificial positive electrode.

The positive electrode active material in the positive electrode active material layer CAL may be present in an amount in a range of about 90 wt % to about 99.5 wt % relative to 100 wt % of the positive electrode active material layer CAL. The binder and the conductive material may each be present in an amount in a range of about 0.5 wt % to about 5 wt % relative to 100 wt % of the positive electrode active material layer CAL.

The binder may be configured to improve attachment of positive electrode active material particles to each other, and to improve attachment of the positive electrode active material to the current collector COLL. The binder may include, for example, at least one of polyvinyl alcohol, carboxymethyl cellulose, hydroxypropyl cellulose, diacetyl cellulose, polyvinylchloride, carboxylated polyvinylchloride, polyvinylfluoride, ethylene oxide-containing polymer, polyvinylpyrrolidone, polyurethane, polytetrafluoroethylene, polyvinylidene fluoride, polyethylene, polypropylene, styrene-butadiene rubber, (meth)acrylated styrene-butadiene rubber, epoxy resin, (meth)acrylic resin, polyester resin, or nylon, but the present disclosure is not limited thereto.

The conductive material may be included to provide an electrode with conductivity, and any suitable conductive material that does not cause a chemical change in a battery may be included as the conductive material. The conductive material may include, for example, a carbon-based material such as at least one of natural graphite, artificial graphite, carbon black, acetylene black, Ketjen black, carbon fiber, carbon nano-fiber, and carbon nano-tube; a metal powder or metal fiber containing one or more of copper, nickel, aluminum, and silver; a conductive polymer such as a polyphenylene derivative; or a mixture thereof.

Aluminum (Al) may be included as the current collector COL1, but the present disclosure is not limited thereto.

### Positive Electrode Active Material

The positive electrode active material in the positive electrode active material layer CAL may include a compound (e.g., lithiated intercalation compound) that can reversibly intercalate and deintercalate lithium. For example, the positive electrode active material may include at least one kind of composite oxide including lithium and metal that is or includes at least one of cobalt, manganese, nickel, and a combination thereof.

The composite oxide may include lithium transition metal composite oxide, for example, at least one of lithium-nickel-based oxide, lithium-cobalt-based oxide, lithium-manganese-based oxide, lithium-iron-phosphate-based compounds, cobalt-free nickel-manganese-based oxide, or a combination thereof.

For example, the positive electrode active material may include a compound expressed by one of chemical formulae below. LiₐA_{1-b}X_{b}O_{2-c}D_{c} (where 0.90≤a≤1.8, 0≤b≤0.5, and 0≤c≤0.05); LiₐMn_{2-b}X_{b}O_{4-c}D_{c} (where 0.90≤a≤1.8, 0≤b≤0.5, and 0≤c≤0.05); LiₐNi_{1-b-c}Co_{b}X_{c}O₂₋ₐDₐ (where 0.90≤a≤1.8, 0≤b≤0.5, 0≤c≤0.5, and 0<α<2); LiₐNi_{1-b-c}Mn_{b}X_{c}O₂₋ₐDₐ (where 0.90≤a≤1.8, 0≤b≤0.5, 0≤c≤0.5, and 0<α<2); LiₐNi_{b}Co_{c}L¹_{d}GₑO₂ (where 0.90≤a≤1.8, 0≤b≤0.9, 0≤c≤0.5, 0≤d≤0.5, and 0≤e≤0.1); LiₐNiG_{b}O₂ (where 0.90≤a≤1.8 and 0.001≤b≤0.1); LiₐCoG_{b}O₂ (where 0.90≤a≤1.8 and 0.001≤b≤0.1); LiₐMn_{1-b}G_{b}O₂ (where 0.90≤a≤1.8 and 0.001≤b≤0.1); LiₐMn₂G_{b}O₄ (where 0.90≤a≤1.8 and 0.001≤b≤0.1); LiₐMn_{1-g}G_{g}PO₄ (where 0.90≤a≤1.8 and 0≤g≤0.5); Li_{(3-f)}Fe₂(PO₄)₃ (where 0≤f≤2); LiₐFePO₄ (where 0.90≤a≤1.8).

In the chemical formulae above, A is or includes at least one of Ni, Co, Mn, or a combination thereof, X is or includes at least one of Al, Ni, Co, Mn, Cr, Fe, Mg, Sr, V, a rare-earth element, or a combination thereof, D is or includes at least one of O, F, S, P, or a combination thereof, G is or includes at least one of Al, Cr, Mn, Fe, Mg, La, Ce, Sr, V, or a combination thereof, and L¹ is or includes at least one of Mn, Al, or a combination thereof.

For example, the positive electrode active material may be a high-nickel-based positive electrode active material having a nickel amount that is equal to or greater than about 80 mol %, equal to or greater than about 85 mol %, equal to or greater than about 90 mol %, equal to or greater than about 91 mol %, or equal to or greater than about 94 mol % and equal to or less than about 99 mol % relative to 100 mol % of metal devoid of lithium in the lithium transition metal composite oxide. The high-nickel-based positive electrode active material may achieve high capacity, and thus may be applied to a high-capacity and high-density rechargeable lithium battery.

### Negative Electrode 20

The negative electrode 20 for a rechargeable lithium battery may include a current collector COL2 and a negative electrode active material layer NAL located on the current collector COL2. The negative electrode active material layer NAL may include a negative electrode active material, and may further include a binder and/or a conductive material.

For example, the negative electrode active material layer NAL may include a negative electrode active material in a range of about 90 wt % to about 99 wt %, a binder in a range of about 0.5 wt % to about 5 wt %, and a conductive material in a range of about 0 wt % to about 5 wt %.

The binder may be configured to improve attachment of negative electrode active material particles to each other, and to improve attachment of the negative electrode active material to the current collector COL2. The binder may include a non-aqueous binder, an aqueous binder, a dry binder, or a combination thereof.

The non-aqueous binder may include at least one of polyvinyl chloride, carboxylated polyvinyl chloride, polyvinyl fluoride, ethylene propylene copolymer, polystyrene, polyurethane, polytetrafluoroethylene, polyvinylidene fluoride, polyethylene, polypropylene, polyamide imide, polyimide, or a combination thereof.

The aqueous binder may include at least one of styrene-butadiene rubber, (meth)acrylated styrene-butadiene rubber, (meth)acrylonitrile-butadiene rubber, (meth)acrylic rubber, butyl rubber, fluoro elastomer, polyethylene oxide, polyvinyl pyrrolidone, polyepichlorohydrin, polyphosphazene, poly(meth)acrylonitrile, ethylene propylene diene copolymer, polyvinyl pyridine, chlorosulfonated polyethylene, latex, polyester resin, (meth)acrylic resin, phenolic resin, epoxy resin, polyvinyl alcohol, or a combination thereof.

When an aqueous binder is included as the negative electrode binder, a cellulose-based compound capable of providing viscosity may further be included. The cellulose-based compound may include one or more of carboxymethyl cellulose, hydroxypropylmethyl cellulose, methyl cellulose, and alkali metal salts thereof. The alkali metal may include at least one of Na, K, or Li.

The dry binder may include a fibrillizable polymer material, for example, at least one of polytetrafluoroethylene, polyvinylidene fluoride, polyvinylidene fluoride-hexafluoropropylene copolymer, polyethylene oxide, or a combination thereof.

The conductive material may be included to provide an electrode with conductivity, and any suitable conductive material that does not cause a chemical change in a battery may be included as the conductive material. For example, the conductive material may include a carbon-based material such as at least one of natural graphite, artificial graphite, carbon black, acetylene black, Ketjen black, carbon fiber, carbon nano-fiber, and carbon nano-tube; a metal powder or metal fiber including one or more of copper, nickel, aluminum, and silver; a conductive polymer such as a polyphenylene derivative; or a mixture thereof.

The current collector COL2 may include at least one of a copper foil, a nickel foil, a stainless-steel foil, a titanium foil, a nickel foam, a copper foam, a polymer substrate coated with a conductive metal, or a combination thereof.

### Negative Electrode Active Material

The negative electrode active material in the negative electrode active material layer NAL may include at least one of a material that can reversibly intercalate and deintercalate lithium ions, lithium metal, a lithium metal alloy, a material that can dope and de-dope lithium, or transition metal oxide.

The material that can reversibly intercalate and deintercalate lithium ions may include a carbon-based negative electrode active material, for example, crystalline carbon, amorphous carbon, or a combination thereof. For example, the crystalline carbon may include graphite such as non-shaped, sheet-shaped, flake-shaped, sphere-shaped, or fiber-shaped natural or artificial graphite, and the amorphous carbon may include at least one of soft carbon, hard carbon, mesophase pitch carbon, or calcined coke.

The lithium metal alloy may include an alloy of lithium and metal that is or includes at least one of Na, K, Rb, Cs, Fr, Be, Mg, Ca, Sr, Si, Sb, Pb, In, Zn, Ba, Ra, Ge, Al, and Sn.

The material that can dope and de-dope lithium may include a Si-based negative electrode active material or a Sn-based negative electrode active material. The Si-based negative electrode active material may include at least one of silicon, silicon-carbon composite, SiOx (where 0<x<2), Si-Q alloy (where Q is or includes at least one of alkali metal, alkaline earth metal, Group 13 element, Group 14 element (with a difference for Si), Group 15 element, Group 16 element, transition metal, a rare-earth element, or a combination thereof), or a combination thereof. The Sn-based negative electrode active material may include at least one of Sn, SnO₂, a Sn-based alloy, a combination thereof.

The silicon-carbon composite may be or include a composite of silicon and amorphous carbon. According to an example embodiment, the silicon-carbon composite may have a structure in which the amorphous carbon is coated on a surface of the silicon particle. For example, the silicon-carbon composite may include a secondary particle (core) in which primary silicon particles are assembled, and an amorphous carbon coating layer (shell) located on a surface of the secondary particle. The amorphous carbon may also be located between the primary silicon particles, and for example, the primary silicon particles may be coated with the amorphous carbon. The secondary particles may be dispersed in an amorphous carbon matrix.

The silicon-carbon composite may further include crystalline carbon. For example, the silicon-carbon composite may include a core including crystalline carbon and silicon particles, and may also include an amorphous carbon coating layer on a surface of the core.

The Si-based negative electrode active material or the Sn-based negative electrode active material may be included in combination with a carbon-based negative electrode active material.

### Separator 30

Based on type of the rechargeable lithium battery, the separator 30 may be present between the positive electrode 10 and the negative electrode 20. The separator 30 may include one or more of polyethylene, polypropylene, and polyvinylidene fluoride, and may have a multi-layered separator thereof such as a polyethylene/polypropylene bi-layered separator, a polyethylene/polypropylene/polyethylene tri-layered separator, and a polypropylene/polyethylene/polypropylene tri-layered separator.

The separator 30 may include a porous substrate and a coating layer located on one surface, or on opposite surfaces, of the porous substrate, and the coating layer includes an organic material, an inorganic material, or a combination thereof.

The porous substrate may be or include a polymer layer including at least one of polyolefin such as polyethylene and polypropylene, polyester such as polyethylene terephthalate and polybutylene terephthalate, polyacetal, polyamide, polyimide, polycarbonate, polyetherketone, polyaryletherketone, polyetherimide, polyamideimide, polybenzimidazole, polyethersulfone, polyphenyleneoxide, cyclic olefin copolymer, polyphenylenesulphide, polyethylene naphthalate, glass fiber, Teflon, and polytetrafluoroethylene, or may be a copolymer or mixture including two or more of the materials mentioned above.

The organic material may include a polyvinylidenefluoride-based copolymer or a (meth)acrylic copolymer.

The inorganic material may include an inorganic particle such as or including at least one of Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, Boehmite, or a combination thereof, but the present disclosure is not limited thereto.

The organic material and the inorganic material may be mixed in one coating layer, or may be present as a stack of a coating layer including the organic material and a coating layer including an inorganic material.

### Electrolyte ELL

The electrolyte ELL for the rechargeable lithium battery may include a non-aqueous organic solvent and a lithium salt.

The non-aqueous organic solvent may be configured as a medium for transmitting ions that participate in an electrochemical reaction of the battery.

The non-aqueous organic solvent may include at least one of a carbonate-based solvent, an ester-based solvent, an ether-based solvent, a ketone-based solvent, an alcohol-based solvent, an aprotic solvent, or a combination thereof.

The carbonate-based solvent may include at least one of dimethyl carbonate (DMC), diethyl carbonate (DEC), dipropyl carbonate (DPC), methylpropyl carbonate (MPC), ethylpropyl carbonate (EPC), methylethyl carbonate (MEC), ethylene carbonate (EC), propylene carbonate (PC), or butylene carbonate (BC).

The ester-based solvent may include at least one of methyl acetate, ethyl acetate, n-propyl acetate, dimethyl acetate, methyl propionate, ethyl propionate, decanolide, mevalonolactone, valerolactone, or caprolactone.

The ether-based solvent may include at least one of dibutyl ether, tetraglyme, diglyme, dimethoxyethane, 2-methyltetrahydrofuran, 2,5-dimethyltetrahydrofuran, or tetrahydrofuran. The ketone-based solvent may include cyclohexanone. The alcohol-based solvent may include at least one of ethyl alcohol or isopropyl alcohol. The aprotic solvent may include at least one of nitriles such as R—CN (where R is a hydrocarbon group having a C2 to C20 linear, branched, or cyclic structure and may include a double bond, an aromatic ring, or an ether group); amides such as dimethylformamide; dioxolanes such as 1,3-dioxolane or 1,4-dioxolane; or sulfolanes.

The non-aqueous organic solvent may be included alone or in a mixture of two or more substances.

In addition, when a carbonate-based solvent is included, a cyclic carbonate and a chain carbonate may be mixed, and the cyclic carbonate and the chain carbonate may be mixed in a volume ratio in a range of about 1:1 to about 1:9.

The lithium salt may be or include a material that dissolves in the non-aqueous organic solvent to be configured as a supply source of lithium ions in a battery and plays a role in enabling a basic operation of a rechargeable lithium battery and in promoting the movement of lithium ions between positive and negative electrodes. The lithium salt may include, for example, at least one of LiPF₆, LiBF₄, LiSbF₆, LiAsF₆, LiClO₄, LiAlO₂, LiAlCl₄, LiPO₂F₂, LiCl, LiI, LiN(SO₃C₂F₅)₂, Li(FSO₂)₂N (lithium bis(fluorosulfonyl)imide, LiFSI), LiC₄F₉SO₃, LiN(CₓF₂ₓ₊₁SO₂)(C_{y}F_{2y+1}SO₂) (where x and y are integers of 1 to 20), lithium trifluoromethane sulfonate, lithium tetrafluoroethanesulfonate, lithium difluoro(oxalato)borate (LiDFOB), lithium difluorobis(oxalato)phosphate (LiDFBOP), and lithium bis(oxalato)borate (LiBOB).

### Rechargeable Lithium Battery

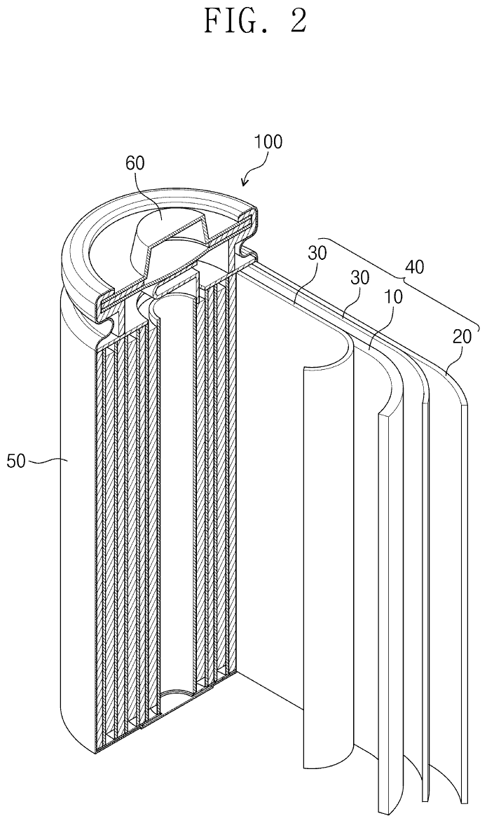

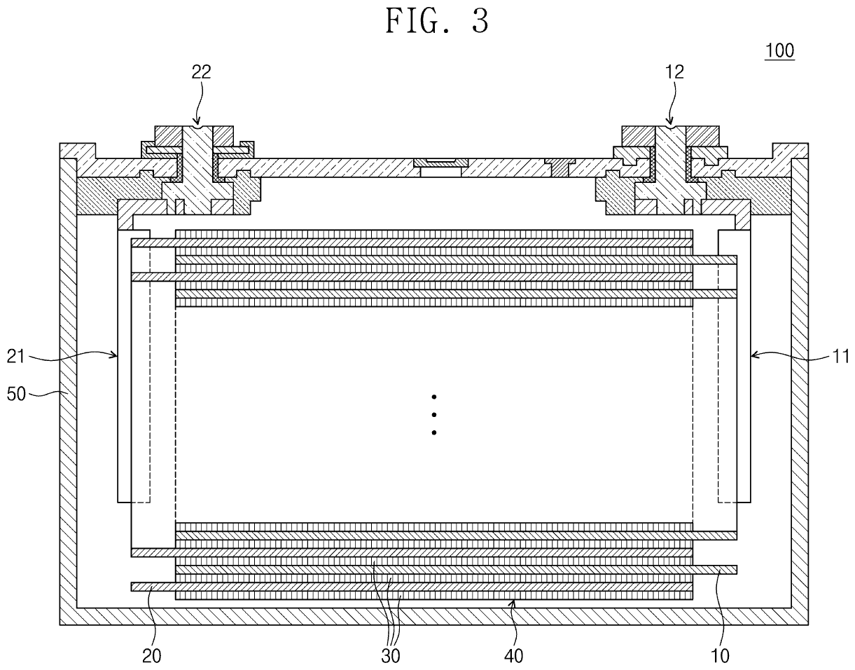

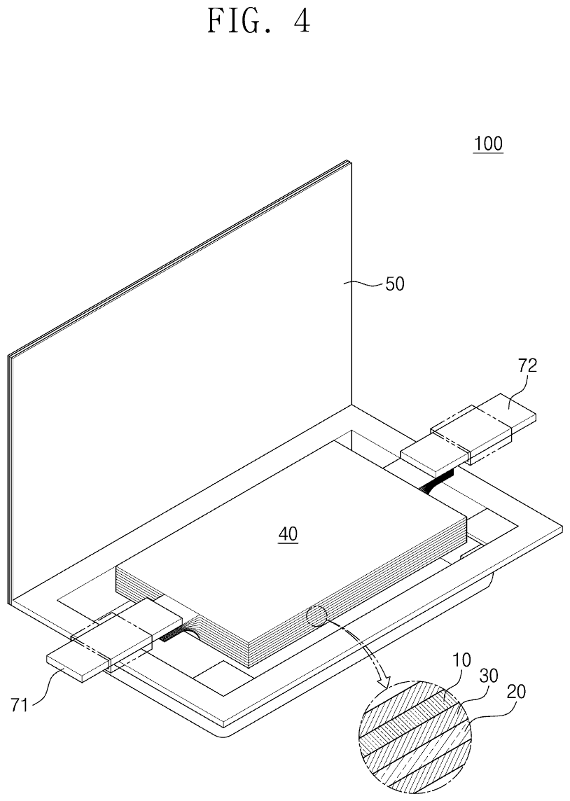

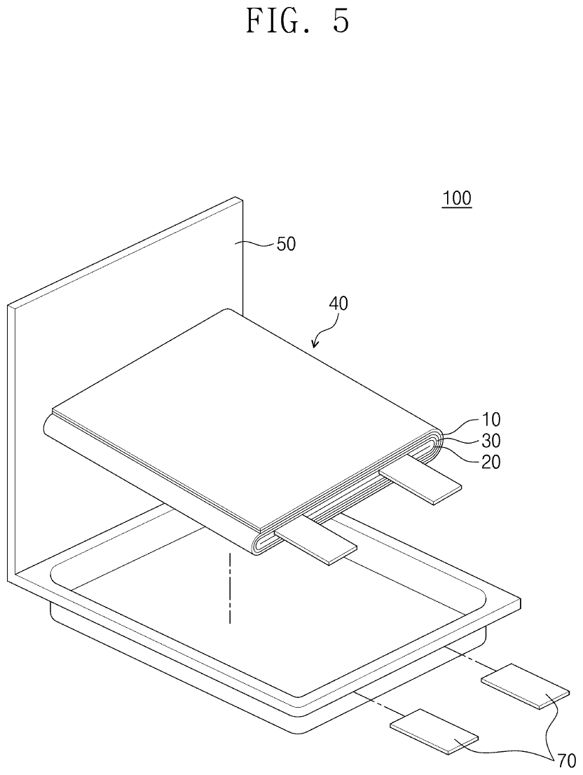

Based on the shape of a rechargeable lithium battery, the rechargeable lithium battery may be classified into cylindrical, prismatic, pouch, and coin types. FIGS. 2 to 5 illustrate simplified diagrams illustrating a rechargeable lithium battery according to an example embodiment, with FIG. 2 illustrating a cylindrical battery, FIG. 3 illustrating a prismatic battery, and FIGS. 4 and 5 illustrating pouch-type batteries. Referring to FIGS. 2 to 4, a rechargeable lithium battery 100 may include an electrode assembly 40 in which a separator 30 is interposed between a positive electrode 10 and a negative electrode 20, and may also include a casing 50 in which the electrode assembly 40 is accommodated. The positive electrode 10, the negative electrode 20, and the separator 30 may be impregnated in an electrolyte (not shown). The rechargeable lithium battery 100 may include a sealing member 60 that seals the casing 50 as illustrated in FIG. 2. In addition, as illustrated in FIG. 3, the rechargeable lithium battery 100 may include a positive electrode lead tab 11, a positive electrode terminal 12, a negative electrode lead tab 21, and a negative electrode terminal 22. As shown in FIGS. 4 and 5, the rechargeable lithium battery 100 may include an electrode tab 70 illustrated in FIG. 5, or a positive electrode tab 71 and a negative electrode tab 72 illustrated in FIG. 4, the electrode tabs 70/71/71 forming an electrical path for externally inducing a current generated in the electrode assembly 40 to the outside of the battery 100.

In the example embodiments that follow, a detailed description of technical features that are redundant to the technical features of the rechargeable lithium battery discussed above with reference to FIGS. 1 to 5 are omitted, and a difference thereof is discussed in detail.

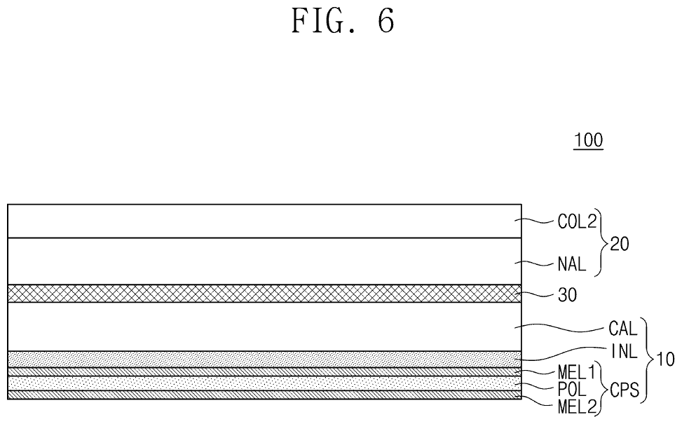

FIG. 6 illustrates a cross-sectional view illustrating a rechargeable lithium battery, according to an example embodiment of the present disclosure. Referring to FIG. 6, a rechargeable lithium battery 100 according to an example embodiment may include a positive electrode 10, a negative electrode 20, and a separator 30 between the positive electrode 10 and the negative electrode 20. The positive electrode 10 may include a composite substrate CPS, a protection layer INL on the composite substrate CPS, and a positive electrode active material layer CAL on the protection layer INL. The composite substrate CPS may include a polymer layer POL, and may also include a first metal layer MEL1 and a second metal layer MEL2 that are correspondingly provided on opposite surfaces of the polymer layer POL. The composite substrate CPS may correspond to the current collector COL1 discussed above with reference to FIG. 1.

In an example embodiment, the rechargeable lithium battery 100 may include a polymer layer POL, a second metal layer MEL2 on a bottom surface of the polymer layer POL, a first metal layer MEL1 on a top surface of the polymer layer POL, a protection layer INL on a top surface of the first metal layer MEL1, a positive electrode active material layer CAL on a top surface of the protection layer INL, a separator 30 on a top surface of the positive electrode active material layer CAL, a negative electrode active material layer NAL on a top surface of the separator 30, and a current collector COL2 on a top surface of the negative electrode active material layer NAL.

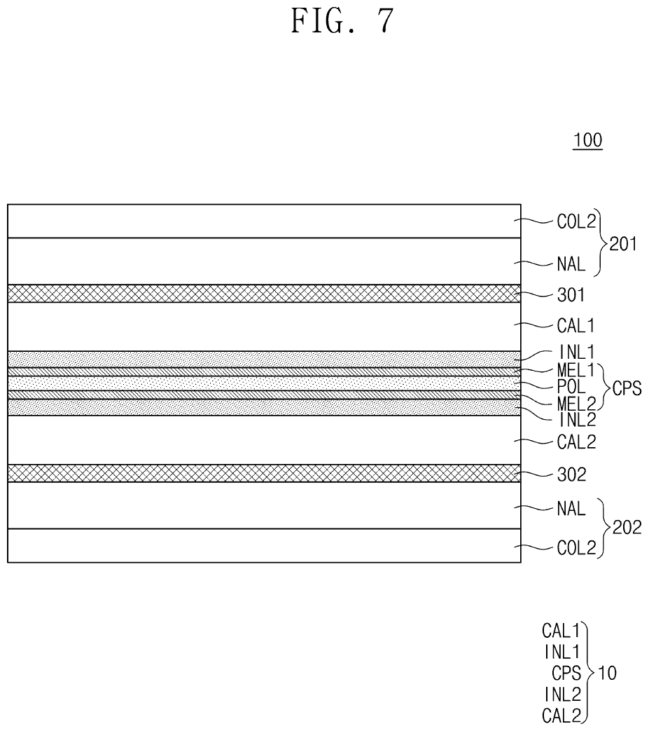

FIG. 7 illustrates a cross-sectional view illustrating a rechargeable lithium battery, according to an example embodiment of the present disclosure. Referring to FIG. 7, a rechargeable lithium battery 100 according to an example embodiment may include a positive electrode 10, a first separator 301 on a top surface of the positive electrode 10, a first negative electrode 201 on a top surface of the first separator 301, a second separator 302 on a bottom surface of the positive electrode 10, and a second negative electrode 202 on a bottom surface of the second separator 302.

Each of, or at least one of, the first and second negative electrodes 201 and 202 may correspond to the negative electrode 20 discussed with reference to FIG. 1. Each of, or at least one of, the first and second separators 301 and 302 may correspond to the separator 30 discussed with reference to FIG. 1.

Referring still to FIG. 7, the positive electrode 10 may include a composite substrate CPS, a first protection layer INL1 on a top surface of the composite substrate CPS, a first positive electrode active material layer CAL1 on a top surface of the first protection layer INL1, a second protection layer INL2 on a bottom surface of the composite substrate CPS, and a second positive electrode active material layer CAL2 on a bottom surface of the second protection layer INL2.

The composite substrate CPS of FIG. 7 may correspond to the composite substrate CPS discussed above with reference to FIG. 6. Each of, or at least one of, the first and second protection layers INL1 and INL2 may correspond to the protection layer INL discussed above with reference to FIG. 6. Each of, or at least one of, the first and second positive electrode active material layers CAL1 and CAL2 may correspond to the positive electrode active material layer CAL discussed above with reference to FIG. 6.

The following description focuses on the positive electrodes discussed above with reference to FIGS. 6 and 7.

### Positive Electrode for Rechargeable Lithium Battery

The positive electrode 10 for a rechargeable lithium battery, according to an example embodiment of the present disclosure may include both a composite substrate including a polymer layer and a protection layer including boron nitride particles, thereby achieving substantially desired or improved penetration safety.

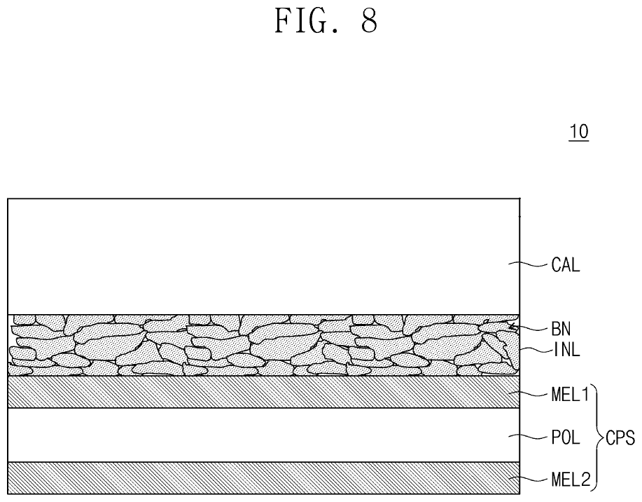

FIG. 8 illustrates an enlarged view illustrating a positive electrode, according to an example embodiment of the present disclosure. Referring to FIG. 8, the positive electrode 10 may include a composite substrate CPS, a protection layer INL on the composite substrate CPS, and a positive electrode active material layer CAL on the protection layer INL.

A thickness of the protection layer INL and/or a loading amount of boron nitride particles BN in the protection layer INL may be adjusted to reduce or block an electrical connection between the composite substrate CPS and an indenter PIN in the event of penetration, while maintaining an electrical connection between the positive electrode active material layer CAL and the composite substrate CPS. The following describes a desired thickness range of the protection layer INL and a loading amount of the boron nitride particles BN.

The composite substrate CPS may include a polymer layer POL, and may also include a first metal layer MEL1 and a second metal layer MEL2 that are correspondingly provided on opposite surfaces of the polymer layer POL.

The polymer layer POL may include a polymer film. The polymer layer POL may include at least one of a polyethylene (PE) film, a polypropylene (PP) film, a polyvinylidene chloride (PVDC) film, a polyethylene terephthalate (PET) film, or a multi-layered film including a combination thereof. For example, the polymer layer POL may be or include a polyethylene terephthalate (PET) film. As the polymer layer POL includes a polymer film, and thus a desired or improved elongation may be achieved.

As the composite substrate CPS includes the polymer layer POL which elongation is desired or improved, improved penetration safety may be accomplished as discussed below.

Each of, or at least one of, the first and second metal layers MEL1 and MEL2 may include at least one of aluminum, aluminum alloys, copper, copper alloys, nickel, nickel alloys, titanium, titanium alloys, iron, iron alloys, silver, and silver alloys. For example, each of, or at least one of, the first and second metal layers MEL1 and MEL2 may be or include an aluminum thin layer.

In an example embodiment of the present disclosure, each of, or at least one of, the first and second metal layers MEL1 and MEL2 may have a thickness in a range of about 0.5 μm to about 2 μm. The polymer layer POL may have a thickness in a range of about 5 μm to about 10 μm. The thickness of the polymer layer POL may be greater than the thickness of each of, or the thickness of at least one of, the first and second metal layers MEL1 and MEL2.

Referring still to FIG. 8, the protection layer INL may include the boron nitride particles BN. The protection layer INL may include the boron nitride particles BN each having a large aspect ratio and a small Young's modulus. Therefore, penetration safety may be improved.

In an example embodiment, the protection layer INL may include the boron nitride particles BN each having an aspect ratio that is equal to or greater than about 10. The inclusion of the boron nitride particles BN each having an aspect ratio that is 10 or greater may achieve desired or improved slip-induced reduction or prevention of short circuits. For example, the protection layer INL may include the boron nitride particles BN each having an aspect ratio in a range of about 10 to about 30 or about 15 to about 25.

In this description, the expression “an aspect ratio of the boron nitride particle BN” may refer to a ratio of length of a major axis to length of a minor axis of the boron nitride particle BN in an electron microscope photograph of the boron nitride particle BN. The minor axis may indicate the shortest axis that passes through a center of the boron nitride particle BN, and the major axis may indicate the longest axis that passes a center of the boron nitride particle BN.

In an example embodiment, the boron nitride particle BN may have an average aspect ratio in a range of about 10 to about 40, or about 10 to about 30. When the average aspect ratio of the boron nitride particle BN is less than the range above, the protection layer INL may have an increased Young's modulus, and it may be more challenging for the protection layer INL to slip in between the indenter PIN and the first metal layer MEL1.

In this description, the expression “an average aspect ratio of the boron nitride particle BN” may indicate an average aspect ratio of approximately 30 randomly selected boron nitride particles BN in an electron microscope photograph. For example, the boron nitride particles BN may have a substantially uniform aspect ratio in the protection layer INL.

In an example embodiment, the boron nitride particle BN in the protection layer INL may be or include a hexagonal boron nitride (h-BN) particle having a hexagonal crystal structure.

In an example embodiment, the boron nitride particle BN may have an average particle diameter (D₅₀) in a range of about 5 μm to about 10 μm. An average particle diameter (D₅₀) may refer to a diameter of a particle at which a cumulative volume is about 50 vol % in a particle size distribution. When the particle has an elliptical shape, a particle diameter may denote an average value of major and minor axes.

In an example embodiment, a mass of the boron nitride particles BN per unit area of the protection layer INL may range from about 0.25 mg/cm² to about 2 mg/cm², or from about 0.25 mg/cm² to about 1 mg/cm². For example, a loading amount of the boron nitride particles BN may range from about 0.25 mg/cm² to about 2 mg/cm², or from about 0.25 mg/cm² to about 1 mg/cm². When the loading amount of the boron nitride particles BN falls within the range above, a short circuit due to penetration may be reduced or prevented without blocking an electrical connection between the positive electrode active material layer CAL and the composite substrate CPS. When the loading amount of the boron nitride particle BN is greater than the range above, electron transfer efficiency between the positive electrode active material layer CAL and the composite substrate CPS may decrease, which may cause a reduction in cell performance. When the loading amount of the boron nitride particle BN is less than the range above, the boron nitride particles BN may not completely fill a gap between the indenter PIN and the first metal layer MEL1, and thus a short circuit may occur.

In an example embodiment, the protection layer INL may have a thickness in a range of about 1 μm to about 12 μm. For example, the protection layer INL may have a thickness in a range of about 2 μm to about 6 μm.

In an example embodiment, the protection layer INL may have a Young's modulus in a range of about 0.1 GPa to about 10 GPa, for example, about 0.2 GPa to about 1.0 GPa.

In an example embodiment, the protection layer INL may further include a binder. There is no particular limitation on a kind of binder, and the binders included in the negative electrode active material layer NAL, or in the positive electrode active material layer CAL discussed above with reference to FIG. 1, may be the same as the binder of the protection layer INL.

In an example embodiment, the protection layer INL may include at least one binder such as or including at least one of acrylate-based binders, polyvinylidene fluoride-based binders, polyvinylpyrrolidone-based binders, polyvinyl alcohol-based binders, and cellulose-based binders.

In an example embodiment, the protection layer INL may include an aqueous binder.

The acrylate-based binder may include, for example, at least one of polyacrylic acid (PAA), polymethylmethacrylate, polyisobutylmethacrylate, polyethylacrylate, polybutyl acrylate, or poly(2-ethylhexyl acrylate).

The polyvinylidene fluoride-based binder may include, for example, at least one of poly(vinylidene fluoride) (PVDF), poly(vinylidene fluoride-co-hexafluoropropylene), poly(vinylidene fluoride-co-trichloroethylene), poly(vinylidene fluoride-co-tetrafluoroethylene), poly(vinylidene fluoride-co-trifluoroethylene), poly(vinylidene fluoride-co-trifluorochloroethylene), poly(vinylidene fluoride-co-ethylenefluoride-hexafluoropropylene, or polyvinylidene fluoride-co-trichloroethylene.

The polyvinylpyrrolidone-based binder may include, for example, polyvinylpyrrolidone.

The polyvinyl alcohol-based binder may be or include, for example, polyvinyl alcohol.

The cellulose-based binder may include, for example, at least one of carboxy methyl cellulose (CMC), methyl cellulose (MC), hydroxypropyl cellulose (HPC), methyl hydroxypropyl cellulose (MHPC), ethyl hydroxyethyl cellulose (EHEC), methyl ethyl hydroxyethyl cellulose (MEHEC), or cellulose gum.

For example, the protection layer INL may include polyvinylidene fluoride (PVDF).

In an example embodiment, the binder of the protection layer INL may be present in an amount in a range of about 0.5 wt % to about 20 wt %.

In an example embodiment, the protection layer INL may further include a small amount of conductive material. As the protection layer INL includes a small amount of conductive material, there may be an increase in electron transfer efficiency between the positive electrode active material layer CAL and the composite substrate CPS. When the protection layer INL includes an excessive or substantial amount of conductive material, there may be a reduction in prevention of short circuit in the event of penetration. There is no particular limitation on a kind of conductive material, and the conductive materials included in the negative electrode active material layer NAL, or the positive electrode active material layer CAL discussed above with reference to FIG. 1, may be the same as the conductive material of the protection layer INL.

In an example embodiment, the conductive material may be included in an amount in a range of about 0.1 wt % to about 2 wt % in the protection layer INL.

In an example embodiment, the positive electrode active material layer CAL may include the positive electrode active material discussed above with reference to FIG. 1.

In an example embodiment, the positive electrode active material layer CAL may include at least one positive electrode active material such as or including at least one of lithium cobalt oxide (LCO), lithium nickel cobalt aluminum oxide (NCA), and lithium nickel cobalt manganese oxide (NCM).

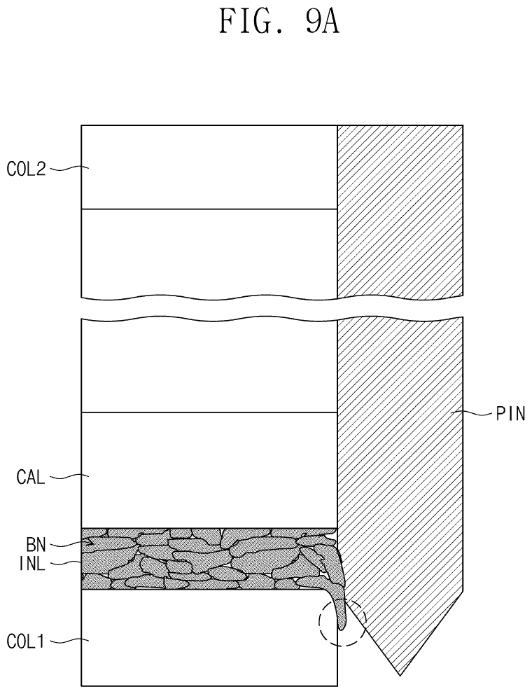

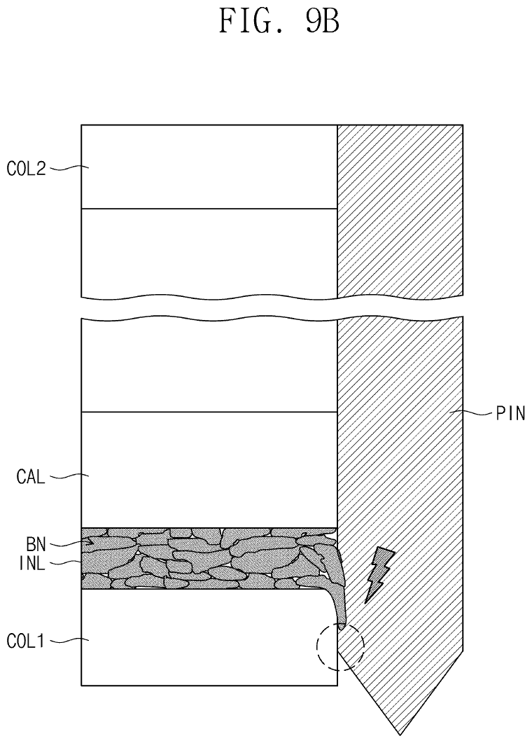

FIGS. 9A and 9B are simplified conceptual diagrams illustrating a principle of reducing or preventing a short circuit caused by penetration in a positive electrode, according to a comparative example of the present disclosure. For example, FIGS. 9A and 9B substantially illustrate a principle of reducing or preventing a short circuit in comparative examples in which the protection layer INL is coated, not on the composite substrate CPS, but on the current collector COL1 formed of or including a metallic material.

Referring to FIG. 9A, the boron nitride particle BN having a large aspect ratio and a small Young's modulus may slip in between the indenter PIN and the current collector COL1, and thus an electrical connection may be reduced or blocked between the indenter PIN and the current collector COLL. However, referring to FIG. 9B, when the boron nitride particle BN does not slip to a lowermost end of the current collector COL1, there may be a likelihood that the slip of the boron nitride particle BN alone cannot completely prevent a short circuit.

In contrast, according to an example embodiment of the present disclosure, as the protection layer INL is coated on the composite substrate CPS, penetration safety may be improved.

FIG. 10 illustrates a simplified conceptual diagram illustrating a principle of reducing or preventing a short circuit caused by penetration in a positive electrode, according to an example embodiment of the present disclosure.

For example, FIG. 10 depicts a simplified conceptual diagram illustrating a principle of reducing or preventing a short circuit when the protection layer INL is coated on the composite substrate CPS, according to an example embodiment of the present disclosure.

Referring to FIG. 10, a positive electrode according to an example embodiment of the present disclosure may include both of the protection layer INL and the polymer layer POL of the composite substrate CPS, and thus a short circuit due to penetration may be more reliably reduced or prevented.

For example, the boron nitride particle BN of the protection layer INL may reduce or block an electrical connection between the indenter PIN and the first metal layer MELL. As discussed above with reference to FIG. 9A, the boron nitride particle BN may slip to reduce or block an electrical connection between the indenter PIN and the first metal layer MELL. Referring to FIG. 10, it may be observed that after penetration of the indenter PIN, the boron nitride particle BN slips to enter the current collector COLL.

The polymer layer POL may reduce or block an electrical connection between the indenter PIN and the second metal layer MEL2. The polymer layer POL may be stretched by the indenter PIN and may be drawn between the indenter PIN and the second metal layer MEL2, thereby reducing or preventing an electrical connection between the indenter PIN and the second metal layer MEL2.

In this sense, the protection layer INL may reduce or prevent an electrical connection between the indenter PIN and the first metal layer MEL1 adjacent to the protection layer INL, and the polymer layer POL may reduce or prevent an electrical connection between the indenter PIN and the second metal layer MEL2, with the result that a short circuit due to penetration may be more reliably reduced or prevented.

Further, when the indenter PIN and the second metal layer MEL2 are electrically connected to each other, the polymer layer POL may be overheated and melted, and a melted polymer may enter between the indenter PIN and the second metal layer MEL2 to act as a fuse to reduce or prevent the occurrence of fire due to a short circuit.

The following describes example embodiments and comparative examples of the present disclosure. The following embodiments, however, are merely examples, and the present disclosure is not limited to the embodiments discussed below.

### Embodiment 1

### Positive Electrode:

### Composite Substrate:

A thermal evaporation method was included to prepare a composite substrate by forming an aluminum thin layer of 1 μm in thickness on each of top and bottom surfaces of a polyethylene terephthalate (PET) film of 8 μm in thickness.

### Protection Layer Slurry:

80 wt % of a hexagonal boron nitride (h-BN) particle having an average particle diameter (D₅₀) of 8 μm and an average aspect ratio of 10, and 20 wt % of polyvinylidene fluoride were mixed in an N-methyl pyrrolidone solvent to prepare a protection layer slurry.

### Positive Electrode Active Material Slurry:

96 wt % of Li₁Co₁O₂ or a positive electrode active material, 2 wt % of Denka black, and 2 wt % of polyvinylidene fluoride were mixed in an N-methyl pyrrolidone solvent to prepare a positive electrode active material slurry.

### Positive Electrode:

The protection layer slurry was coated on the prepared composite substrate, and then dried to form a protection layer. The protection layer slurry was coated to allow hexagonal boron nitride (h-BN) to have a mass of 0.5 mg/cm² per unit area of the protection layer (amount of boron nitride (BN): 0.5 mg/cm²). Afterwards, the prepared positive electrode active material slurry was coated on the protection layer, and then dried to form a positive electrode active material layer. Then, the mixture was pressed to manufacture a positive electrode.

### Negative Electrode:

98 wt % of artificial graphite, 0.8 wt % of carboxymethyl cellulose, and 1.2 wt % of styrene-butadiene rubber were mixed in pure water to prepare a negative electrode active material slurry. The negative electrode active material slurry was coated and dried on a copper (Cu) film, and then pressed to manufacture a negative electrode.

### Rechargeable Lithium Battery:

The positive electrode, the negative electrode, and an electrolyte were included in a typical method to fabricate a rechargeable lithium battery. The electrolyte was prepared by dissolving 1.0 M LiPF₆ in a solvent containing ethylene carbonate and diethyl carbonate mixed in a volume ratio of 50:50.

### Embodiment 2

A positive electrode, a negative electrode, and a rechargeable lithium battery were fabricated in the same method as in Embodiment 1, with a difference that a hexagonal boron nitride (h-BN) particle having an average aspect ratio of 18 was included when the protection layer slurry was prepared.

### Embodiment 3

A positive electrode, a negative electrode, and a rechargeable lithium battery were fabricated in the same method as in Embodiment 1, with a difference that a hexagonal boron nitride (h-BN) particle having an average aspect ratio of 25 was included when the protection layer slurry was prepared.

### Embodiment 4

A positive electrode, a negative electrode, and a rechargeable lithium battery were fabricated in the same method as in Embodiment 1, with a difference that a hexagonal boron nitride (h-BN) particle having an average aspect ratio of 30 was included when the protection layer slurry was prepared.

### Embodiment 5

A positive electrode, a negative electrode, and a rechargeable lithium battery were fabricated in the same method as in Embodiment 1, with a difference that a hexagonal boron nitride (h-BN) particle having an average aspect ratio of 40 was included when the protection layer slurry was prepared.

### Embodiment 6

A positive electrode, a negative electrode, and a rechargeable lithium battery were fabricated in the same method as in Embodiment 1, with a difference that a hexagonal boron nitride (h-BN) particle having an average aspect ratio of 18 was included when the protection layer slurry was prepared, and that the protection layer slurry was coated to allow hexagonal boron nitride (h-BN) to have a mass of 0.25 mg/cm² per unit area of the protection layer (amount of boron nitride (BN): 0.25 mg/cm²).

### Embodiment 7

A positive electrode, a negative electrode, and a rechargeable lithium battery were fabricated in the same method as in Embodiment 1, with a difference that a hexagonal boron nitride (h-BN) particle having an average aspect ratio of 18 was included when the protection layer slurry was prepared, and that the protection layer slurry was coated to allow hexagonal boron nitride (h-BN) to have a mass of 1 mg/cm² per unit area of the protection layer (amount of boron nitride (BN): 1 mg/cm²).

### Comparative 1

A positive electrode, a negative electrode, and a rechargeable lithium battery were fabricated in the same method as in Embodiment 1, with a difference that the protection layer slurry of Embodiment 1 was replaced with the following LFP slurry as a functional layer slurry when the positive electrode was manufactured. When the positive electrode was manufactured, the following LFP slurry was coated and dried on the composite substrate to form a functional layer of 4 μm in thickness.

### LFP Slurry

87 wt % of LiFePO₄ having an average particle diameter (D₅₀) of 1.2 μm, 12 wt % of polyvinylidene fluoride (PVDF), and 1 wt % of hydrogenated nitrile-butadiene rubber (H-NBR) were mixed in an N-methyl pyrrolidone (NMP) solvent to prepare a functional layer slurry.

### Comparative 2

A positive electrode, a negative electrode, and a rechargeable lithium battery were fabricated in the same method as in Embodiment 1, with a difference that the composite substrate of Embodiment 1 was replaced with an aluminum foil of 10 μm in thickness when the positive electrode was manufactured. In this case, the protection layer and the positive electrode active material layer were formed on the aluminum foil to manufacture the positive electrode.

### Comparative 3

A positive electrode, a negative electrode, and a rechargeable lithium battery were fabricated in the same method as in Embodiment 1, with a difference that a hexagonal boron nitride (h-BN) particle having an average aspect ratio of 18 was included when the protection layer slurry was prepared, and that the protection layer slurry was coated to allow hexagonal boron nitride (h-BN) to have a mass of 0.1 mg/cm² per unit area of the protection layer (amount of boron nitride (BN): 0.1 mg/cm²).

### Comparative 4

A positive electrode, a negative electrode, and a rechargeable lithium battery were fabricated in the same method as in Embodiment 1, with a difference that a hexagonal boron nitride (h-BN) particle having an average particle diameter (D₅₀) of 8 μm and an average aspect ratio of 18 was included when the protection layer slurry was prepared, and that the protection layer slurry was coated to allow hexagonal boron nitride (h-BN) to have a mass of 3 mg/cm² per unit area of the protection layer (amount of boron nitride (BN): 3 mg/cm²).

Table 1 below shows characteristics of the positive electrodes according to Embodiments and Comparatives mentioned above.

TABLE 1

| | | | | Average | Young's |
|---|---|---|---|---|---|
| | | BN | Kind of | aspect | modulus of |
| | | loading | positive | ratio of | functional |
| | | amount | electrode | boron nitride | layer |
| | Functional layer | (mg/cm²) | substrate | particle | (GPa) |
| Embodiment 1 | BN protection | 0.5 | Composite | 10 | 0.99 |
| | layer | | substrate | | |
| Embodiment 2 | BN protection | 0.5 | Composite | 18 | 0.65 |
| | layer | | substrate | | |
| Embodiment 3 | BN protection | 0.5 | Composite | 25 | 0.21 |
| | layer | | substrate | | |
| Embodiment 4 | BN protection | 0.5 | Composite | 30 | 0.15 |
| | layer | | substrate | | |
| Embodiment 5 | BN protection | 0.5 | Composite | 40 | 0.09 |
| | layer | | substrate | | |
| Embodiment 6 | BN protection | 0.25 | Composite | 18 | — |
| | layer | | substrate | | |
| Embodiment 7 | BN protection | 1 | Composite | 18 | — |
| | layer | | substrate | | |
| Comparative 1 | LFP layer | — | Composite | — | 2.44 |
| | | | substrate | | |
| Comparative 2 | BN protection | 0.5 | Typical | 18 | 20 |
| | layer | | substrate | | |
| Comparative 3 | BN protection | 0.1 | Composite | 18 | — |
| | layer | | substrate | | |
| Comparative 4 | BN protection | 3 | Composite | 18 | — |
| | layer | | substrate | | |

### Evaluation Example 1: Penetration Safety Evaluation 1

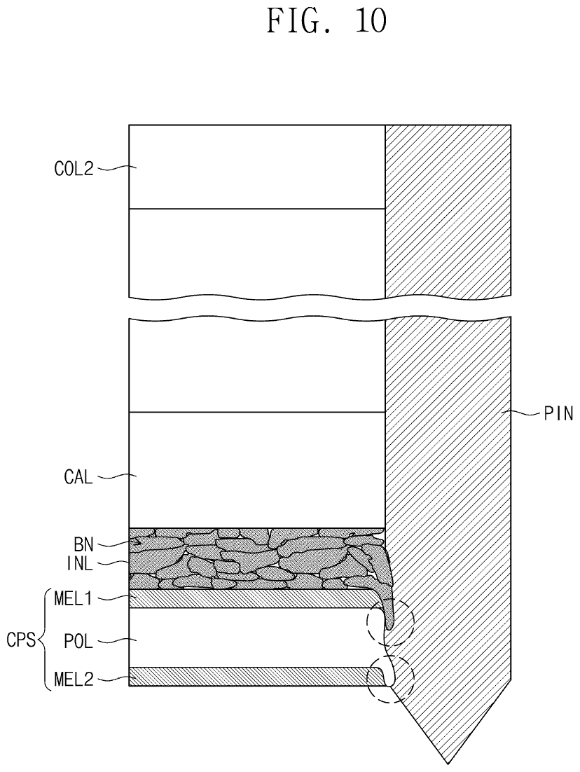

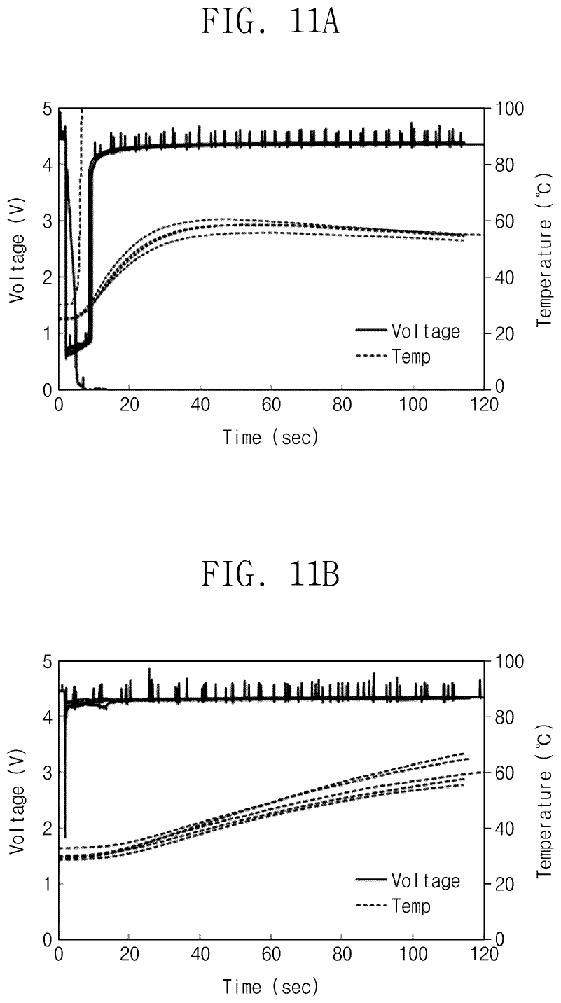

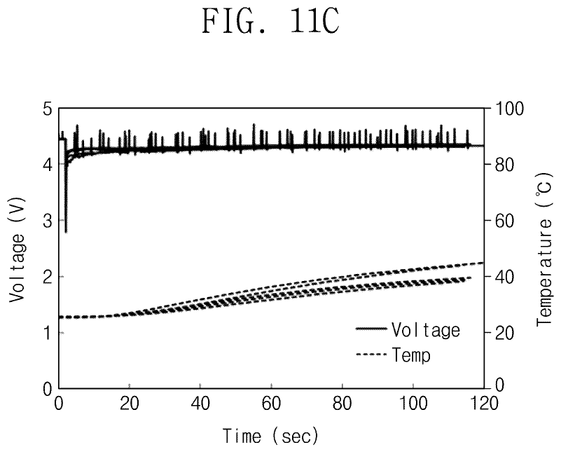

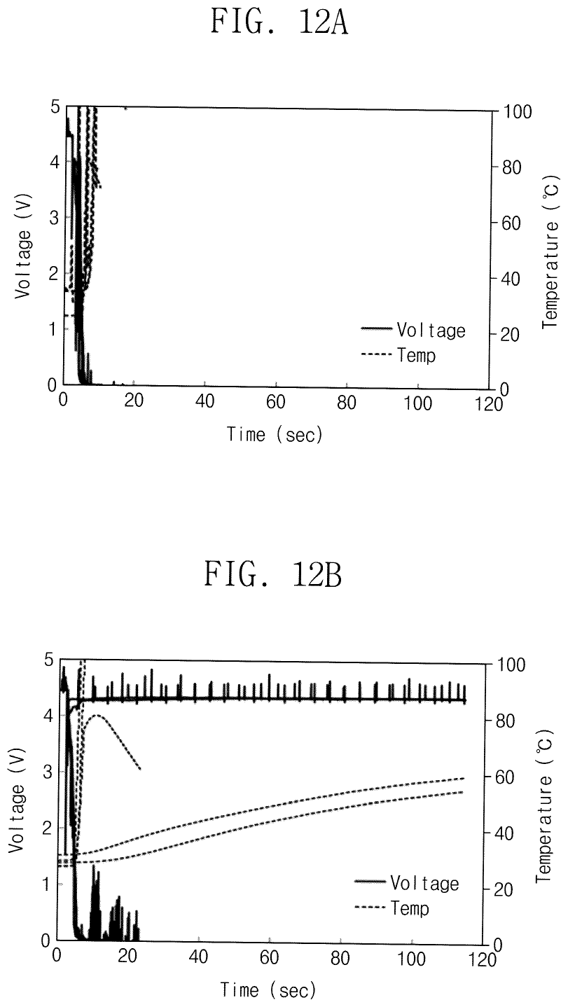

Each of the rechargeable lithium batteries fabricated according to embodiments and comparative examples was charged for 3 hours at 0.5 C to 4.25 V, stored for about 10 minutes (up to 72 hours if needed), and then a pin of 5 mm in diameter was used to fully penetrate a center of the battery at a speed of 60 mm/sec. After measuring temperature changes over time after penetration, and a maximum heating temperature is listed in Table 2 below. In addition, FIGS. 11A to 11C show changes with time in temperature and voltage after penetration in Embodiments 1, 6, and 7 in order, and FIGS. 12A and 12B show changes with time in temperature and voltage after penetration in Comparatives 1 and 2 in order.

TABLE 2

| | Maximum heating temperature |
|---|---|
| | (° C.) |
| Embodiment 1 | 60.4 |
| Embodiment 2 | 48.5 |
| Embodiment 3 | 54 |
| Embodiment 4 | 46.4 |
| Embodiment 5 | 85.2 |
| Embodiment 6 | 69.7 |
| Embodiment 7 | 42.3 |
| Comparative 1 | 483.5 |
| Comparative 2 | 520.4 |
| Comparative 3 | 340.6 |
| Comparative 4 | 45.4 |

Referring to FIGS. 12A to 12C and Table 2, the rechargeable lithium batteries according to Embodiments 1 to 7 exhibited a maximum heating temperature that is less than 100° C. and desired or improved penetration safety, whereas the rechargeable lithium batteries according to Comparatives 1 to 3 exhibited a maximum heating temperature of 300° C. or greater and poor penetration safety.

### Evaluation Example 2: Penetration Safety Evaluation 2

Five rechargeable lithium batteries were prepared for each of embodiments and comparative examples. Each of the prepared rechargeable lithium batteries was charged at 0.5 C to 4.50 V under the condition of constant current and 0.05 C cut-off charged under the condition of constant voltage, stored for about 1 day (up to 72 hours if needed), and then a pin of 3 mm in diameter was used to fully penetrate a center of the battery at a speed of 150 mm/sec. The occurrence of ignition due to penetration was measured, and the result is shown in Table 3 below.

TABLE 3

| | Number of ignited cells |
|---|---|
| Embodiment 1 | 1 |
| Embodiment 2 | 0 |
| Embodiment 3 | 0 |
| Embodiment 4 | 0 |
| Embodiment 5 | 0 |
| Embodiment 6 | 0 |
| Embodiment 7 | 0 |
| Comparative 1 | 5 |
| Comparative 2 | 3 |
| Comparative 3 | 2 |
| Comparative 4 | 0 |

Referring to Table 3, it may be ascertained that the rechargeable lithium batteries of Comparative 1, each including the LFP functional layer instead of the boron nitride (BN) protection layer, experienced fires in all five cells due to penetration and exhibited poor penetration safety. It may also be ascertained that there was a reduction in penetration safety in the case where the BN protection layer was included and the Al foil was used in place of the composite substrate (Comparative 2), or in the case where the BN loading amount of the BN protection layer was excessively small (Comparative 3).

In contrast, it may be ascertained that the rechargeable lithium batteries according to Embodiments 1 to 7 each including both of the composite substrate and the protection layer exhibited dramatically reduced occurrence of fire due to penetration.

### Evaluation Example 3: Evaluation of Rechargeable Lithium Battery Capacity

Each of the rechargeable lithium batteries fabricated according to Embodiment 2 and Comparative 4 was charged under the condition of constant current (0.2 C) and constant voltage (4.25 V and 0.05 C cut-off) to measure a charge capacity, stored for 10 minutes, and then discharged to 3.0 V under the condition of constant current (0.2 C) to measure a discharge capacity. Table 4 below shows initial charge capacities and charge/discharge efficiency or a ratio of the discharge capacity to the charge capacity.

TABLE 4

| | Initial | Initial | Charge/ |
|---|---|---|---|
| | charge | discharge | discharge |
| | capacity | capacity | efficiency |
| | (mAh/g) | (mAh/g) | (%) |
| Embodiment 2 | 205.1 | 184.8 | 90.1 |
| Comparative 4 | 197 | 172.3 | 87.3 |

Referring to Table 4, it may be ascertained that there was an excessive reduction in initial charge/discharge capacity and efficiency of the rechargeable lithium battery of Comparative 4 including the positive electrode having an excessive loading amount of BN in the protection layer, and it may be interpreted that the reduction in charge/discharge capacity and efficiency was attributed to impaired electron transfer.

A positive electrode according to the present inventive concepts, and a rechargeable lithium battery including the positive electrode, may have desired or improved safety. For example, the positive electrode according to the present inventive concepts may include a boron-nitride protection layer to reduce or prevent a short circuit due to penetration.

What is claimed is:

1. A positive electrode for a rechargeable lithium battery, the positive electrode comprising:
a composite substrate that includes a first metal layer, a second metal layer, and a polymer layer between the first metal layer and the second metal layer;
a protection layer on the first metal layer; and
a positive electrode active material layer on the protection layer,
wherein the protection layer includes boron nitride particles.

2. The positive electrode of claim 1, wherein an aspect ratio of the boron nitride particles is equal to or greater than about 10.

3. The positive electrode of claim 1, wherein an average aspect ratio of the boron nitride particles is in a range of about 10 to about 30.

4. The positive electrode of claim 1, wherein an average particle diameter of the boron nitride particles is in a range of about 5 μm to about 10 μm.

5. The positive electrode of claim 1, wherein the boron nitride particles comprise hexagonal boron nitride particles.

6. The positive electrode of claim 1, wherein:
a thickness of at least one of the first metal layer and the second metal layer is in a range of about 0.5 μm to about 2 μm, and
a thickness of the polymer layer is in a range of about 5 μm to about 10 μm.

7. The positive electrode of claim 1, wherein, in the protection layer, a mass of the boron nitride particles per unit area of the protection layer is in a range of about 0.25 mg/cm² to about 1.0 mg/cm².

8. The positive electrode of claim 1, wherein the positive electrode active material layer comprises at least one positive electrode active material comprising at least one of lithium cobalt oxide (LCO), lithium nickel cobalt aluminum oxide (NCA), and lithium nickel cobalt manganese oxide (NCM).

9. A positive electrode for a rechargeable lithium battery, the positive electrode comprising:
a composite substrate that includes a first metal layer, a second metal layer, and a polymer layer between the first metal layer and the second metal layer;
a first protection layer on a top surface of the first metal layer;
a second protection layer on a bottom surface of the second metal layer;
a first positive electrode active material layer on a top surface of the first protection layer; and
a second positive electrode active material layer on a bottom surface of the second protection layer,
wherein at least one of the first protection layer and the second protection layer comprises boron nitride particles.

10. The positive electrode of claim 9, wherein each of the first protection layer and the second protection layer comprise boron nitride particles having an aspect ratio that is equal to or greater than about 10.

11. The positive electrode of claim 9, wherein an average aspect ratio of the boron nitride particles is in a range of about 10 to about 30.

12. The positive electrode of claim 9, wherein an average particle diameter of the boron nitride particles is in a range of about 5 μm to about 10 μm.

13. The positive electrode of claim 9, wherein the boron nitride particles comprise hexagonal boron nitride particles.

14. The positive electrode of claim 9, wherein:
a thickness of each of the first metal layer and the second metal layer is in a range of about 0.5 μm to about 2 μm, and
a thickness of the polymer layer is in a range of about 5 μm to about 10 μm.

15. The positive electrode of claim 9, wherein, in the protection layer, a mass of the boron nitride particles per unit area of the first protection layer is in a range of about 0.25 mg/cm² to about 2.0 mg/cm².

16. The positive electrode of claim 9, wherein each of the first and second positive electrode active material layers comprises at least one positive electrode active material comprising at least one of lithium cobalt oxide (LCO), lithium nickel cobalt aluminum oxide (NCA), and lithium nickel cobalt manganese oxide (NCM).

17. A rechargeable lithium battery, comprising:
a positive electrode, a negative electrode, and a separator between the positive electrode and the negative electrode,
wherein the positive electrode includes:
a composite substrate that includes a first metal layer, a second metal layer, and a polymer layer between the first metal layer and the second metal layer;
a protection layer on the first metal layer, wherein the protection layer includes boron nitride; and
a positive electrode active material layer on the protection layer.

18. The rechargeable lithium battery of claim 17, wherein the protection layer includes boron nitride particles having an aspect ratio that is equal to or greater than about 10.

19. The rechargeable lithium battery of claim 17, wherein
an average aspect ratio of the boron nitride is in a range of about 10 to about 30, and
an average particle diameter of the boron nitride is in a range of about 5 μm to about 10 μm.

20. The rechargeable lithium battery of claim 17, wherein the boron nitride comprises hexagonal boron nitride.
